(19) United States
(12) Patent Application Publication
(10) Pub. No.: US 2014/0032109 A1
(43) Pub. Date: Jan. 30, 2014

(54) ROUTE RECOMMENDATION SYSTEM AND METHOD THEREOF

(71) Applicant: INSTITUTE FOR INFORMATION INDUSTRY, Taipei (TW)

(72) Inventors: Wen-Tai HSIEH, Taipei City (TW); Chun-Hung LU, Taipei City (TW); Wen-Nan WANG, New Taipei City (TW); Yi-Hsun LEE, Taichung City (TW); Jia-Min REN, Hsinchu City (TW); Jyh-Shing JANG, Taipei City (TW)

(21) Appl. No.: 13/916,792

(22) Filed: Jun. 13, 2013

(30) Foreign Application Priority Data
Jul. 30, 2012 (TW) 101127391

(51) Int. Cl. G01C 21/34

(52) U.S. Cl. CPC G01C 21/34
USPC 701/533; 701/537

(57) ABSTRACT

A route recommendation system is provided. The system has: a data querying apparatus configured to generate query information according to a location; and a data analyzing apparatus, connected to the data querying apparatus, having: a database configured to store at least one candidate data, wherein each candidate data has a candidate location, at least one recommended location corresponding to the candidate location, and a recommended staying time of each recommended location; a data receiving unit configured to receive the query information; and a processing unit configured to generate at least one recommended route according to the query information and the candidate data, and transmit the at least one recommended route to the data querying apparatus, wherein the recommended route comprises a path from the location to the at least one recommended location, and the recommended staying time corresponding to each recommended location.

### CROSS REFERENCE TO RELATED APPLICATIONS

This application claims priority of Taiwan Patent Application No. 101127391, filed on Jul. 30, 2012, the entirety of which is incorporated by reference herein.

### BACKGROUND OF THE INVENTION

1. Field of the Invention

The present invention relates to a route recommendation system and method thereof, and in particular relates to a recommendation system and method thereof capable of generating at least one recommended location and a recommended staying time corresponding to each recommended location.

2. Description of the Related Art

With advances in technologies, it has become more and more popular to use a mobile device to schedule or navigate routes. In addition, social networks are also prospering. When people are going outdoors for sight seeing or travel, or shopping in a specific store, they can use their mobile devices to “check-in” on a social website. That is, their mobile devices can be used to record time and location information, and upload the recorded time and location information to a social website. However, when planning routes or providing a navigation function, a conventional mobile device on the market may merely provide one or several routes from a start location to a destination location, or the estimated route time. That is, the user has to set two locations first, and then the conventional mobile device may plan routes according to the geographical locations of the two locations. In addition, the conventional mobile device may estimate the time required in the planned routes according to the vehicle type, the travel speed, and the particular route. Nevertheless, the conventional mobile device can not recommend routes when a start location is given without specifying destination locations. Thus the conventional mobile device can not plan routes for the unspecified locations and can not recommend a staying time for the unspecified destination locations in the planned route either.

When a user wants to schedule travel routes or has arrived at an unfamiliar location, the need for planning routes or navigation is highly demanded by the user. Further, when a user is visiting attractions which the user has never been to or the user is under an unfamiliar circumstance, it is not easy to plan a schedule and travel routes since the user does not know what location or store he can visit next or the user can not estimate how much time he should allocate for each location and store. In another case, a user may have planned his schedule and routes in advance. The user may have some spare time or decide to change the schedule temporarily after visiting a certain specific location, and thus he may change or modify the remaining schedule and routes temporarily according to the current location and the remaining time. However, the conventional mobile devices on the market can not recommend routes and the staying time thereof fitting the user's need. Accordingly, there is a demand for a route recommendation system capable of generating recommended routes having at least one location and the recommended staying time thereof according to a location selected by the user, so that it is convenient for the user to plan routes.

### BRIEF SUMMARY OF THE INVENTION

A detailed description is given in the following embodiments with reference to the accompanying drawings.

In an exemplary embodiment, a route recommendation system is provided. The system comprises: a data querying apparatus configured to generate query information according to a location; and a data analyzing apparatus, connected to the data querying apparatus, comprising: a database configured to store at least one candidate data, wherein each candidate data comprises a candidate location, at least one recommended location corresponding to the candidate location, and a recommended staying time of each recommended location; a data receiving unit configured to receive the query information; and a processing unit configured to generate at least one recommended route according to the query information and the at least one candidate data, and transmit the at least one recommended route to the data querying apparatus, wherein the at least one recommended route comprises a path from the location to the at least one recommended location, and the recommended staying time corresponding to the at least one recommended location.

In another exemplary embodiment, a route recommendation method applied in a route recommendation system is provided. The route recommendation system comprises a data querying apparatus and a data analyzing apparatus. The data analyzing apparatus, which is connected to the data querying apparatus, comprises a database, a data receiving unit and a processing unit. The method comprises the following steps of: generating query information according to a location via the data querying apparatus; storing at least one candidate data via the database, wherein each candidate data comprises a candidate location, at least one recommended location corresponding to the candidate location, and a recommended staying time of each recommended location; receiving the querying information via the data receiving unit; generating at least one recommended route according to the query information and the at least one candidate data via the processing unit; and transmitting the at least one recommended route to the data querying apparatus, wherein the at least one recommended route comprises a path from the location to the at least one recommended location, and the recommended staying time corresponding to each recommended location.

In yet another exemplary embodiment, a non-transitory storage medium for being read for being read by a data querying apparatus and a data analyzing apparatus to execute a route recommendation method is provided. The data analyzing apparatus, which is connected to the data querying apparatus, comprises a database, a data receiving unit, and a processing unit. The method comprises the following steps of: generating query information according to a location via the data querying apparatus; storing at least one candidate data via the database, wherein each candidate data comprises a candidate location, at least one recommended location corresponding to the candidate location, and a recommended staying time of each recommended location; receiving the querying information via the data receiving unit; generating at least one recommended route according to the query information and the at least one candidate data via the processing unit; and transmitting the at least one recommended route to the data querying apparatus, wherein the at least one recommended route comprises a path from the location to the at least one recommended location, and the recommended staying time corresponding to each recommended location.

### BRIEF DESCRIPTION OF THE DRAWINGS

The present invention can be more fully understood by reading the subsequent detailed description and examples with references made to the accompanying drawings, wherein:

FIG. 1 is a block diagram illustrating a route recommendation system 100 according to an embodiment of the invention;

FIGS. 2A˜2B are diagrams illustrating multiple move data according to an embodiment of the invention;

FIGS. 3A˜3D are diagrams illustrating multiple n-gram sequential route data according to the embodiment of FIGS. 2A˜2B in the invention;

FIGS. 4A˜4B are diagrams illustrating multiple move data according to another embodiment of the invention;

FIG. 5 is a diagram illustrating querying routes by using the user interface according to an embodiment of the invention;

FIGS. 6A˜6D are diagrams illustrating calculation of n-gram sequential route data and the number of occurrences by using an SMAP-Tree according to an embodiment of the invention;

FIGS. 7A˜7C are diagrams illustrating different recommended travel routes according to different embodiments of the invention; and

FIG. 8 is a flow chart illustrating a route recommendation method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

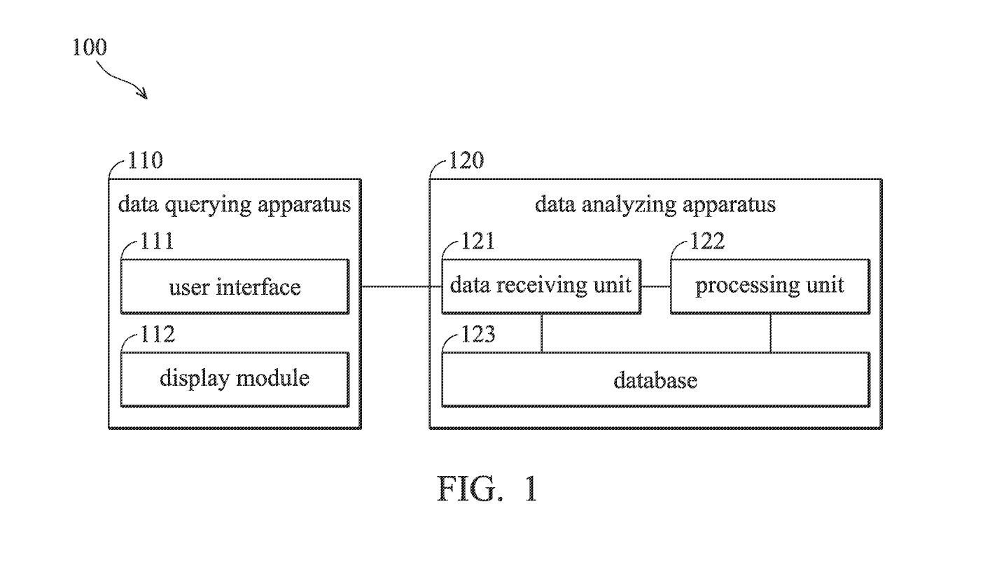

FIG. 1 is a block diagram illustrating a route recommendation system 100 according to an embodiment of the invention. The route recommendation system 100 may comprise a data querying apparatus 110 and a data analyzing apparatus 120. The data analyzing unit 120 is connected to the data querying apparatus 110 through a wired or wireless communications network, or through a physical transmission wire (e.g. an RS232 interface) or a data bus. In another embodiment, the data querying apparatus 100 may comprise a user interface 111 and a display module 112. A user may select or input a location (e.g. an attraction name, an address, a landmark, a GPS coordinate) on the user interface 111 displayed on the display module 112 to query a route corresponding to the location. Meanwhile, the data querying apparatus 110 may generate query information according to the location, and transmit the query information to the data analyzing apparatus 120. For example, the user interface 111 may be a user interface circuit or a software operation interface, such as an electronic map and at least one input field displayed on the display module 112, so that the user may select a location on the electronic map as an input location, or enter texts in the input field as the input location. In some embodiments, the data querying apparatus 110 can be implemented by a cellular phone, a tablet PC, a personal digital assistant (PDA), a navigation device, a global positioning system (GPS), a laptop, or a personal computer. The display module 112 may be a display or a monitor with corresponding drivers of the data querying apparatus 110.

The data analyzing apparatus 120 may comprise a data receiving unit 121, a processing unit 122, and a database 123. The database 123 may store at least one candidate data, wherein each candidate data may comprise a candidate location, at least one recommended location corresponding to the candidate location, and a recommended staying time of each recommended location. The data receiving unit 121 is configured to receive the query information from the data querying apparatus 110. The processing unit 122 may retrieve a candidate location and at least one recommended location thereof corresponding to the location from the database 123 according to the querying information and the at least one candidate data stored in the database 123, and generate at least one recommended route according to the at least one recommended location. Then, the processing unit 122 may transmit the generated at least one route to the data querying apparatus 110, thereby displaying the at least one recommended route.

The at least one recommended route displayed by the data querying apparatus 110 may comprise at least one path from the location to the at least one recommended location, and the recommended staying time corresponding to each recommended location. The at least one recommended route may be displayed as a map on the user interface 111. For example, the location, the at least one recommended location, at least one path from the location to the at least one recommended location, and the recommended staying time corresponding to each recommended location are displayed on the map. In addition, there are also multiple selectable locations (e.g. a list of candidate points, or candidate points marked on the map) provided on the user interface 111 for the user. Then, the processing unit 122 may generate the query information according to the selectable location selected by the user, and generate at least one recommended route according to the query information. The query result can be illustrated as a map, which corresponds to the location and the at least one recommended route, on the user interface 111 displayed on the display module 112. For example, the illustrated map may comprise the location, the at least one recommended location, at least one path from the location to the at least one recommended location, and a recommended staying time corresponding to each recommended location.

Further, the at least one candidate data can be generated by the processing unit 122 in advance and stored into the database. Specifically, the processing unit 122 may calculate and generate each candidate data, such as at least one recommended location corresponding to the candidate location and a recommended staying time corresponding to each recommended location, according to multiple pieces of time information and corresponding location information (i.e. move data) of at least one user within a time period. Then, the processing unit 122 may store each candidate data (e.g. the candidate location, at least one recommended location corresponding to the candidate location, and a recommended staying time of each recommended location) in the database 123. Accordingly, when the data receiving unit 121 receives the query information from the data querying apparatus 110, the processing unit 122 may match the queried location with candidate locations stored in the database 123 quickly to obtain matching candidate locations and provide a recommended route which comprises the recommended location and the recommended staying time thereof in real time. Briefly, the candidate data may represent multiple recommended routes for different candidate locations, and the recommended routes may comprise different recommended locations and the recommended staying time corresponding to each recommended location. Thus, when the user has inputted a location on the user interface 111, the processing unit 122 may find the recommended routes matching the user's need from the candidate data. In addition, the candidate data may be occasionally, or periodically, calculated and generated by the processing unit 122, thereby updating the candidate data stored in the database 123.

In another embodiment, the data receiving unit 121 may retrieve multiple pieces of time information and corresponding location information of at least one user within a period of time from the internet, a social network, or a mobile device (e.g. a cellular phone, a tablet PC, or a laptop). The retrieved information may be data corresponding to different users, which records time-to-location information of each user in an unspecified period of time (e.g. several hours, a day, or five days). For example, the retrieved information may be check-in information having time and location information in a social network (e.g. Facebook, foursquare), photos having time and location information (e.g. Flickr, Panoramio), videos having time and location information, or documents embedded with time and location information (e.g. Evernote). After analysis or processing of the data, the retrieved data, having location information in a period of time, can be regarded as move data. Given that the data querying apparatus 110 is a smart phone or a tablet PC, the user may record multiple pieces of time information and corresponding location information of the user within a period of time by using the data querying apparatus 110. For example, the data querying apparatus 110 may be used to check-in on a social website, take photos of an attraction, or make location information on documents. Thus, the data analyzing apparatus 120 may retrieve the multiple pieces of time information and corresponding location information of the user from the check-in information on the social website, the photos of the attraction, or the documents marked with location information, and the retrieved time information and location information may be transmitted to the data analyzing apparatus 120 to generate move data. Specifically, the data analyzing apparatus 120 may retrieve the capturing time and the GPS coordinates from the comment data of the photos, retrieve corresponding time and location data from the documents by using sentence segmentation and text analysis techniques, or retrieve the location or GPS coordinates of the checked-in location from the social website, but the invention is not limited thereto.

In some embodiments, the processing unit 122 may generate at least one candidate data according to multiple pieces of time information and corresponding location information of at least one user within a period of time. The aforementioned time information and corresponding location information of each user may indicate a set of move data associated with a user in any period of time, and each set of move data may comprise at least two pieces of time-to-location information, and each piece of time-to-location information comprises a piece of time information and location information. Details will be described in the following sections.

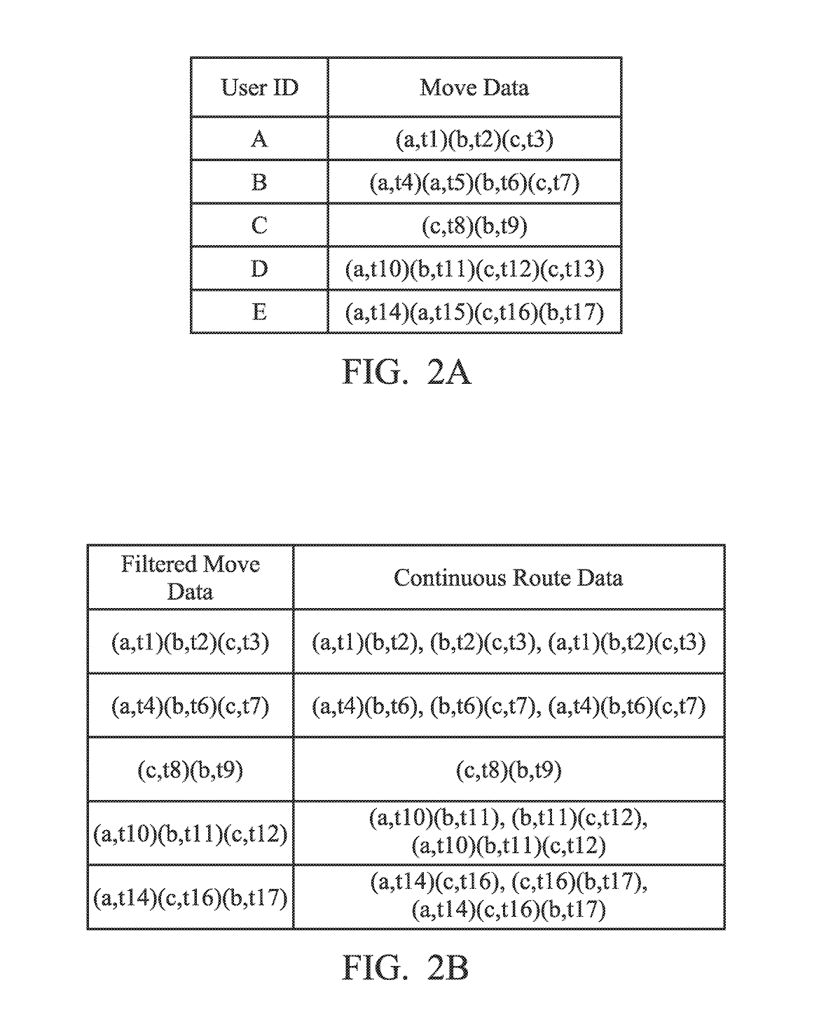

FIGS. 2A˜2B are diagrams illustrating multiple move data according to an embodiment of the invention. In another embodiment, the processing unit 122 may analyze the received time information and location information, such as checkin information, having time and location information on a social network, photos having time and location information, videos having time and location information, or documents marked with time and location information, to generate multiple move data. Each move data at least comprises location and time data. In addition, each move data may further comprise other data, such as the user's account, a coordinate, time, a title, or a type of travel route, and the processing unit 122 may determine which move data to record according to different needs. As illustrated in FIG. 2A, the move data of the user A are (a, t1), (b, t2), (c, t3); the move data of the user B are (a, t4), (a, t5), (b, t6), (c, t7); the move data of the user C are (c, t8), (b, t9); the move data of the user D are (a, t10), (b, t11), (c, t12), (c, t13); the move data of the user E are (a, t14), (a, t15), (c, t16), (b, t17), wherein each lowercase letter denotes a different location, and t1˜t17 denotes different times. For example, the location a may be an attraction “Yingge Ceramics Museum”; the location b may be an attraction “Yingge Ceramics Old Street”; the location c may be an attraction “Yingge Grandma's Sushi Shop”. Briefly, each move data may be a location-time-sequence data, which indicates the geographical location of each user and corresponding time in each attraction. It should be noted that the aforementioned embodiment is for brief description. In fact, each set of move data in the invention may further record user identification data, and type of the move data. For example, the move data of the user A may be (a, t1, A, 1), (b, t2, A, 3), (c, t3, A, 4), wherein A denotes the user identification data indicating that the move data is generated by the user A; numbers 1˜4 denote data indicating different types of the move data for activities, such as 1 for “checkin on a social website”, 2 for “sight-seeing”, 3 for “pottery throwing”, and 4 for “having meals”, but the invention is not limited thereto. Briefly, each set of move data may comprise at least two sets of time-to-location information, and each set of time-to-location information may at least comprise a piece of time information (e.g. time t1˜t17 in the aforementioned embodiment) and location information (e.g. locations a˜c in the aforementioned embodiment), and additionally comprise the types (e.g. type 1˜4 in the aforementioned embodiment) of the move data and the user identification data. In a specific embodiment, in order to facilitate data processing, multiple sets of time-to-location information within the same set of move data are arranged in chronological order. For example, the move data of the user A are (a, t1), (b, t2) and (c, t3), and the chronological order from the earliest to the latest is t1, t2, and t3. In addition, in a set of move data of a user, there may be more than one piece of move data in the same location. For example, there may be pieces of move data, which are generated by the user in different ways (e.g. checkin on a social website, taking photos) at the same location, within the same set of move data. For example, as illustrated in FIG. 2A, the set of move data of the user B may comprise two pieces of move data (a, t4) and (a, t5) at the location a, and the set of move data of the user D may comprise two pieces of move data (c, t12), and (c, t13) at the location c. When calculating and generating each candidate data, the processing unit 122 may filter move data of the same user at the same location. That is, when there are many pieces of move data at the same location within the same set of move data, only one piece of move data is selected as the filtered move data. For example, there are two pieces of move data (a, t4) and (a, t5) associated with the user B in FIG. 2A, and the processing unit 122 may retrieve the move data (a, t4) as a representing move data at the location a. In other words, the retrieved move data (a, t4) can be regarded as the filtered move data, as illustrated in FIG. 2B, in subsequent calculations for coordinating the sequential route data of users, thereby generating the candidate data. Further, the processing unit 122 may further generate a set of routes comprising multiple sequential route data according to multiple sets of filtered move data, and then calculate of the number of occurrences of each sequential route data in the multiple sets of filtered move data. The processing unit 122 may further generate at least one recommended location corresponding to each candidate point according to the number of occurrences of each sequential route data. In some embodiments, each sequential route data may be at least two consecutive time-to-location information retrieved from any set of the filtered move data, and details are described in the following section.

As illustrated in FIG. 2B, after generating filtered move data, the processing unit 122 may generate sequential route data, which comprises any two consecutive locations, any three consecutive locations, any four consecutive locations, or more consecutive locations, as a set of routes from each filtered move data. For example, the filtered move data of the user A are (a, t1), (b,t2) and (c, t3), and thus the sequential route data comprising any two consecutive locations are (a,t1)(b,t2) and (b,t2)(c,t3), and the sequential route data comprising any three consecutive locations are (a,t1)(b,t2)(c,t3). Similarly, the sequential route data associated with the user B are (a, t4)(b, t6), (b, t6)(c, t7), and (a, t4)(b, t6)(c, t7), and the sequential route data associated with the user C are (c, t8)(b, t9). For one having an ordinary skill in the art, it is appreciated that the aforementioned embodiment is for description, and each set of move data is not limited to the three pieces of move data in the invention.

In some other embodiments, the method for generating sequential route data from the filtered move data can be further implemented by the following embodiment. The processing unit 122 may retrieve sequential route data in different lengths from each filtered move data. For example, a sequential route data having two consecutive time-to-location information may be regarded as a 2-gram sequential route data (e.g. (a, t1)(b, t2) or (b, t2)(c, t3)). Similarly, a sequential route data having n consecutive time-to-location information may be regarded as n-gram sequential route data. In other words, a sequential route data having at least one consecutive time-to-location information can be generated from each filtered move data, and then the processing unit 122 may generate at least 2-gram sequential route data for subsequent calculations from each and every filtered move data. Then, the processing unit 122 may gather statistics of all the aforementioned sequential route data, such as the numbers of occurrences of each 2-gram sequential route data, by using LMAP-Mine, SMAP-Mine or T-MAP-MINE algorithms. When the number of occurrences of a certain sequential route data exceeds a threshold value, the processing unit 122 may determine the sequential route data as one of candidate data. Generally, when a sequential route data has a high number of occurrences, the sequential route data can be regarded as candidate data of a popular route. Subsequently, the processing unit 122 may generate recommended routes from candidate data according to the location inputted by the user and default filter criteria. For example, the default filter criteria may indicate retrieving candidate data having sequential route data with the longest length and matching the location, or retrieving candidate data having the largest number of occurrence and matching the location. Alternatively, the default filter criteria may further indicate retrieving candidate data, which has sequential route data with a certain length over a first threshold value and a number of occurrences over a second threshold value, matching the location, or retrieving candidate data, which has continuous data with the longest length and the largest number of occurrences, matching the location.

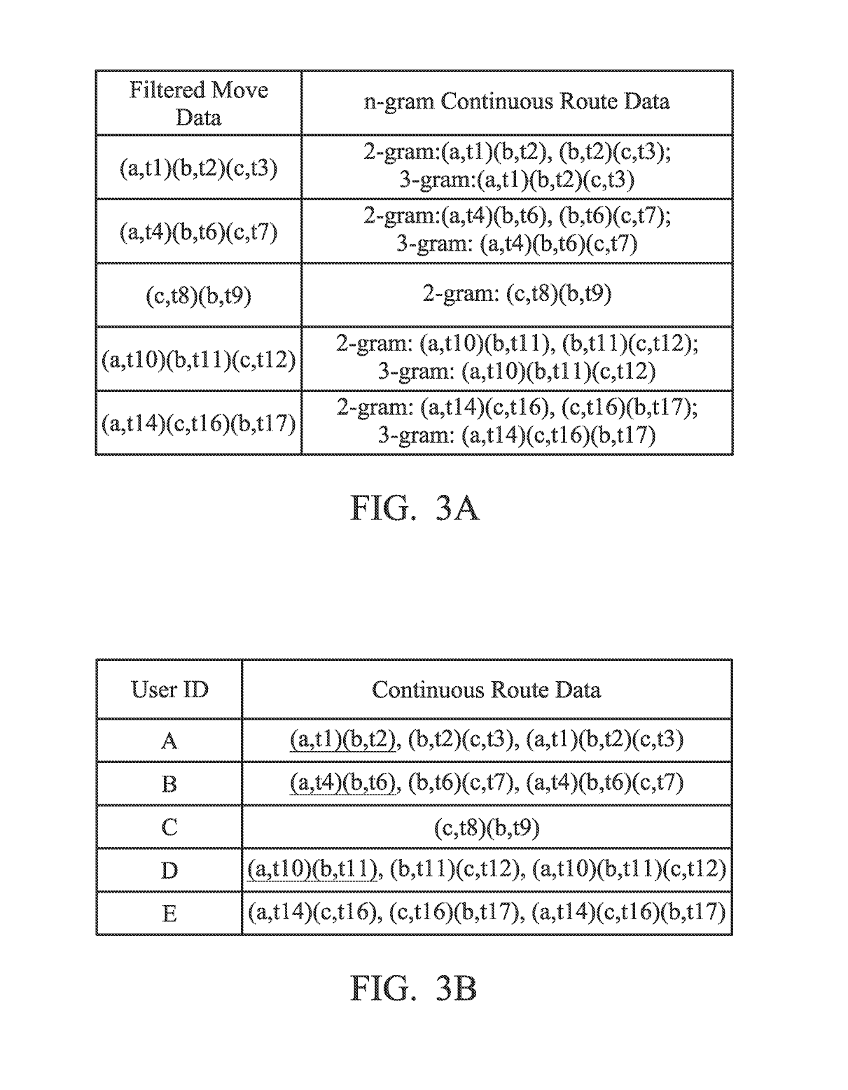

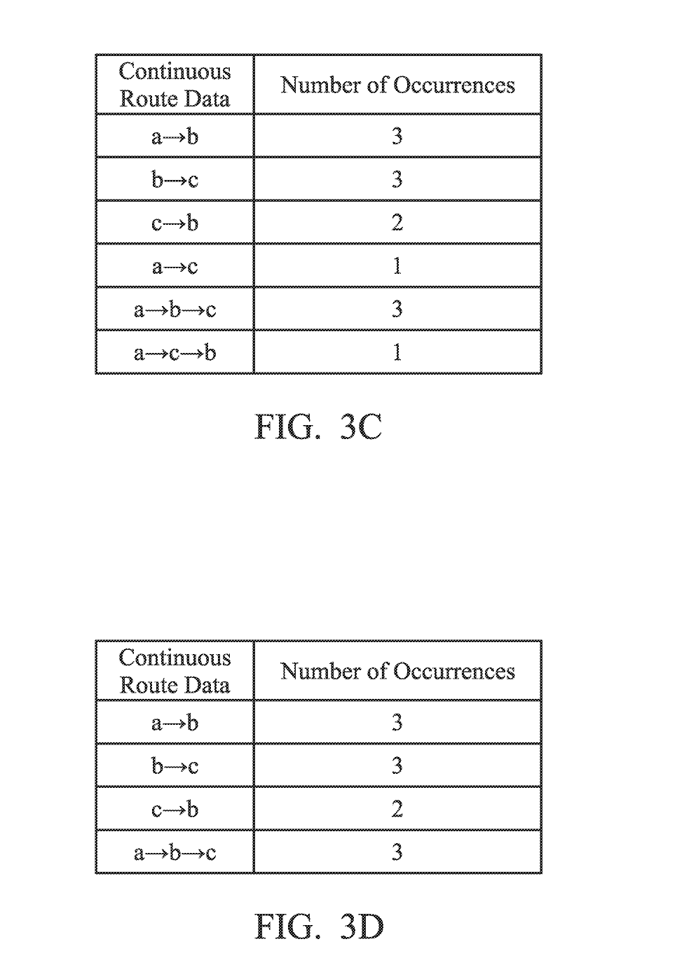

FIGS. 3A˜3D are diagrams illustrating multiple n-gram sequential route data according to the embodiment of FIGS. 2A˜2B in the invention. In the embodiment of FIGS. 2A˜2B, multiple n-gram sequential route data can be generated from the respective filtered move data associated with users A˜E, as illustrated in FIG. 3A. For example, given that the processing unit 122 generates n-gram sequential route data according to the move data (a, t1)(b, t2)(c, t3) associated with the user A, since there are only three pieces of move data associated with the user A, the generated 2-gram sequential route data may comprise (a, t1)(b, t2) and (b, t2)(c, t3), and the generated 3-gram sequential route data may comprise (a, t1)(b, t2)(c, t3). Similarly, the processing unit 122 may generate respective n-gram sequential route data from the filtered move data associated with other users.

Further, as illustrated in FIG. 3B, the processing unit 122 may list all sequential route data associated with each user according to all the generated n-gram sequential route data in FIG. 3A. Then, the processing unit 122 may count the number of occurrences of each sequential route data according to the data in FIG. 3B, and the results are illustrated in FIG. 3C. In the embodiment, each sequential route data may represent multiple locations which a certain user has passed by in a period of time, and it may indicate that each sequential route data has continuity in time. Accordingly, the recorded time in each move data may be ignored while calculating the number of occurrences of each sequential route data and generating candidate data. For example, when calculating the number of occurrences of a sequential route data a→b, it should be appreciated that the sequential route data associated with the users A, B, and D may comprise the sequential route data a→b according to the data in FIG. 3B. Thus, the number of occurrences of the sequential route data a→b calculated by the processing unit 122 is 3. Subsequently, the processing unit 122 may calculate the number of occurrences of each sequential route data in an analogous manner, thereby obtaining the statistics table of numbers of occurrences of all the sequential route data, as illustrated in FIG. 3C. In other words, each sequential route data in FIG. 3C may be regarded as a possible candidate data.

Generally, a sequential route data having a very small number of occurrences can be regarded as an unpopular route, which can be omitted from the candidate data. Accordingly, the processing unit 122 may compare the respective number of occurrences of each sequential route data in FIG. 3C with a predetermined number (e.g. 2 in the embodiment, but the invention is not limited thereto. The predetermined number can be determined according to the actual amount of data, and remove the sequential route data having a number of occurrences smaller than the predetermined number. In other words, the processing unit 122 may preserve the sequential route data having a number of occurrences larger than or equal to the predetermined number, and each preserved sequential route data can be set as one of the candidate data. If a certain sequential route data has the largest number of occurrences, the sequential route data can be regarded as one of the most popular candidate data, such as routes a→b, b→c, and a→b→c illustrated in FIG. 3D. Specifically, the at least one candidate data generated by the processing unit 122 can be stored in the database 123, and the start location of each candidate data (e.g. the location a in the route a→b→c) can be regarded as a candidate location of the candidate data. Other locations except the start location of each candidate data (e.g. locations b and c in the route a→b→c) can be regarded as at least one recommended location of the candidate data.

In the aforementioned embodiment, details for generating candidate data are described in FIGS. 3A˜3D. Then, the details for generating a recommended staying time of each recommended location are described in the following embodiment. Generally, a user may visit various different locations in a route, and the staying time in each location may be different. For example, if a specific location is a beautiful attraction, or the user has plenty of time to visit the specific location, the user may stay at the specific location for a longer time. Conversely, when the user does not have plenty of time to visit a specific location, or there is little of interest in the specific location, the user may not stay at the specific location for a long time. In yet another embodiment, the processing unit 122 may calculate a recommended staying time for each recommended location in each candidate data according to the time-to-location information in each move data. For example, the processing unit 122 may subtract the latest recorded time by the earliest recorded time at the same location for the same user, thereby retrieving the staying time of the user at the location. The retrieved staying time can be regarded as the recommended staying time of the location. That is, if there is continuous data at the same location within a move data, the processing unit 122 may subtract the latest recorded time by the earliest recorded time at the location, thereby estimating the amount of time spent by the user at the location. For example, as illustrated in FIG. 2A, the processing unit 122 may subtract t5 by t4 in the move data associated with the user B, thereby obtaining the staying time of the user B at the location a. Similarly, the processing unit 122 may obtain the staying time of different users in each location. When there are multiple staying times at a certain location, the multiple staying time can be averaged or weighted, and the calculated staying time can be regarded as the recommended staying time of the location. The recommended staying time of each location can be recorded in each candidate data. That is, each candidate data may comprise the recommended location and the recommended staying time thereof. When the processing unit 122 selects a recommended route from multiple candidate data, the processing unit 122 may obtain the recommended location and its recommended staying time on the recommended route as well. Alternatively, the recommended staying time of each location can be recorded in the database 123. When the processing unit selects a recommended route from multiple candidate data, the processing unit 122 may only obtain the recommended location on the recommended route. Then, the processing unit 122 may further retrieve the recommended staying time associated with the recommended location on the travel route according to the recorded recommended staying time of the recommended location in the database 123.

Specifically, if there is only one time data corresponding to each location in a set of move data, the processing unit 122 may estimate the staying time of the user at each location by using actual geographical information. For example, as illustrated in FIG. 2A, the move data associated with the user A are (a, t1)(b, t2)(c, t3), and the locations a˜c may correspond to a respective geographical location (e.g. a GPS coordinate) or a relative position data, for calculating the route distance between any two locations. That is, the processing unit 122 may calculate the route distance (or direct distance) between the locations a and b, and the route distance between locations b and c, and then estimate the driving time x1 from the location a to b and driving time x2 from the location b to c, respectively. The processing unit 122 may use the recorded time at the locations a and b to estimate the arrival time of the user to the location b and the location c are t1+x1 and t2+x2, respectively. Subsequently, the processing unit 122 may subtract the estimated arrival time at the locations b and c with the estimated driving time to the locations b and c, thereby obtaining the staying time, such as t2−(t1+x1) and t3-(t2+x2), of the user A at the locations a and b, respectively. Similarly, the processing unit 122 may further obtain the staying time of different users at other locations. In addition, the processing unit 122 may further calculate the time interval between the earliest recorded time and the latest recorded time in each route, thereby retrieving the total journey time of each route.

Additionally, the processing unit 122 may further build a longest candidate data indicating a route having the largest amount of location data. For example, when the data querying apparatus 110 generates query information according to a specific location, the processing unit 122 may filter multiple candidate data having the specific location as the start location from the database 123, and the filtered candidate data may be at least 2-gram sequential route data. Meanwhile, the processing unit 122 may compare each other sequential route data with the 2-gram sequential route data by taking the 2-gram sequential route data as a start point (i.e. and then 3-gram, 4-gram, or sequential route data having more grams will be determined). If there is no sequential route data longer than 2-gram after comparison, the 2-gram sequential route data can be regarded as the candidate data, which matches the specific location, having the longest route. If there is other n-gram sequential route data longer than 2-gram such as 3-gram sequential route data, the 3-gram sequential route data will be compared with other sequential route data if there is other n-gram sequential route data longer than 3-gram. The aforementioned method will be executed repeatedly until all the n-gram sequential route data have been compared and a longest route has been generated. Further, when it is known that the longest route is x-gram, the processing unit 122 may regard the x-gram sequential route data having the largest number of occurrences as the recommended route according to the numbers of occurrences of all the x-gram sequential route data. As illustrated in FIG. 3C, when the longest route is a 3-gram sequential route data (i.e. x=3), the 3-gram sequential route data having the largest number of occurrences is the route a→b→c, the processing unit 122 may determine the longest route a→b→c having the largest number of occurrences as the recommended route. In some other embodiments, the invention can be further applied to recommending travel routes. For example, when a user selects a predetermined attraction through the user interface 111, the processing unit 122 may set the selected predetermined attraction as a start location (i.e. the location a in the aforementioned embodiment), and generate at least one recommended travel route having the selected predetermined attraction as a start location according to the candidate data stored in the database 123.

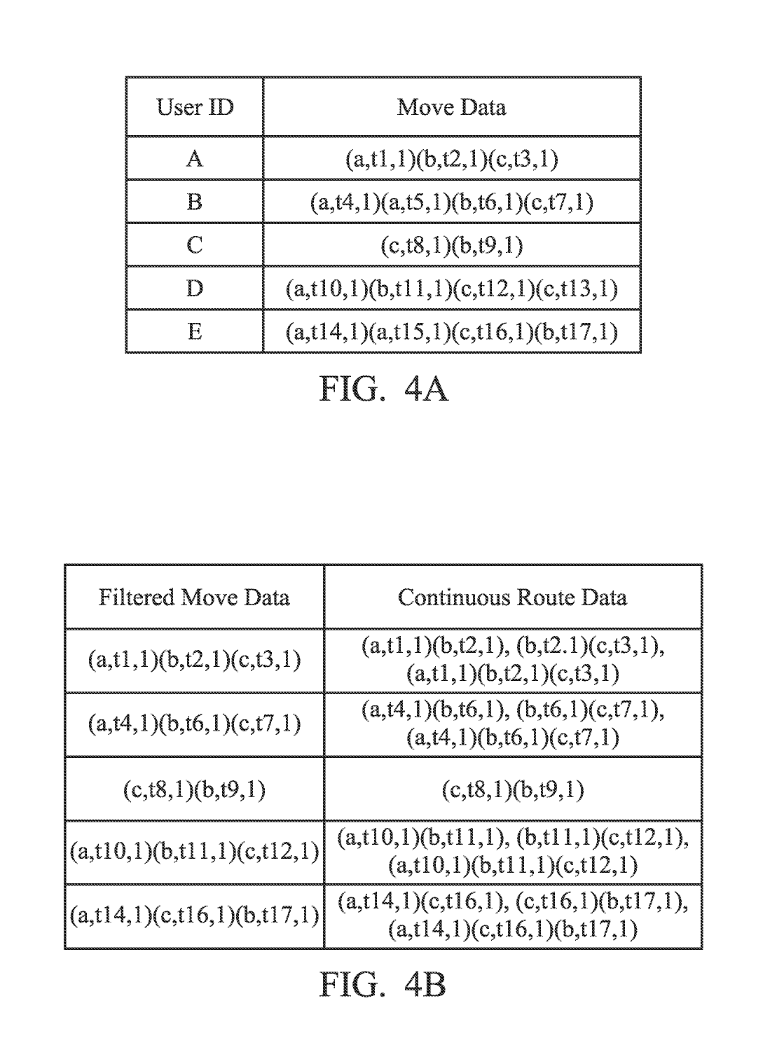

FIGS. 4A˜4B are diagrams illustrating multiple move data according to another embodiment of the invention. In the embodiment of FIGS. 4A and 4B, each move data may further comprise types of the move data in addition to location data and time data. For example, different behaviors or services performed by each user in different attractions can be classified into different types of the move data, such as travel routes of friends in a social network, delicious food, or historic monuments, but the invention is not limited thereto. In the embodiment, when generating candidate data, the processing unit 122 may further generate the recommended routes, the recommended locations and the recommended staying time corresponding to each recommended location according to multiple pieces of time information, corresponding location information and type information of each user within a period of time. In other words, the location information and type information can be parameters for generating candidate data by the processing unit 122, and the candidate data generated from the location and type information can be stored in the database 123. The ways to generate the candidate data can be referred to the aforementioned embodiments and FIGS. 2A˜2B and 3A˜3D. The difference between FIGS. 4A˜4B and FIGS. 2A˜2B and 3A˜3D is that the processing unit 122 may build the candidate data according to a specific type of the move data. That is, the processing unit 122 may filter the move data according to a specific type. The criteria for filtering the move data may indicate retrieving the move data comprising at least one piece of time information and corresponding location/type information as the specific type, or retrieving the move data comprising at least two consecutive pieces of time information and corresponding location/type information as the specific type from all the move data. There are various implementation ways to filter the move data according to the specific type, but the invention is not limited to the aforementioned embodiments.

FIG. 4A illustrates the filtered move data associated with the users A˜E given that the type of the move data is 1, wherein the location a denotes the attraction “Yingge Ceramics Museum”; the location b denotes the attraction “Yingge Ceramics Old Street”; and the location c denotes the attraction “Yingge Grandma's Sushi Shop”. For example, numbers 1˜4 in each move data denote the type of the move data, such as number 1 for “checkin on a social website”, number 2 for “sight-seeing”, number 3 for “pottery throwing”, and number 4 for “having meals”. Data in the left column in the table of FIG. 4 may indicate the filtered move data at the same location by using the method described in the aforementioned embodiment. The processing unit 122 may generate sequential route data (e.g. data in the right column in the table of FIG. 4B) according to the filtered move data, and the details will not be described here again. In other embodiments, a user may select a specific location and a specific type as the query information through the user interface 111, and the database 123 may further store the candidate data generated by the specific location and the specific type. Accordingly, the processing unit 122 may generate at least one recommended route according to the specific location and the specific type inputted by the user, and the at least one recommended route may comprise routes from the specific location to at least one recommended location, and the recommended staying time corresponding to each recommended location.

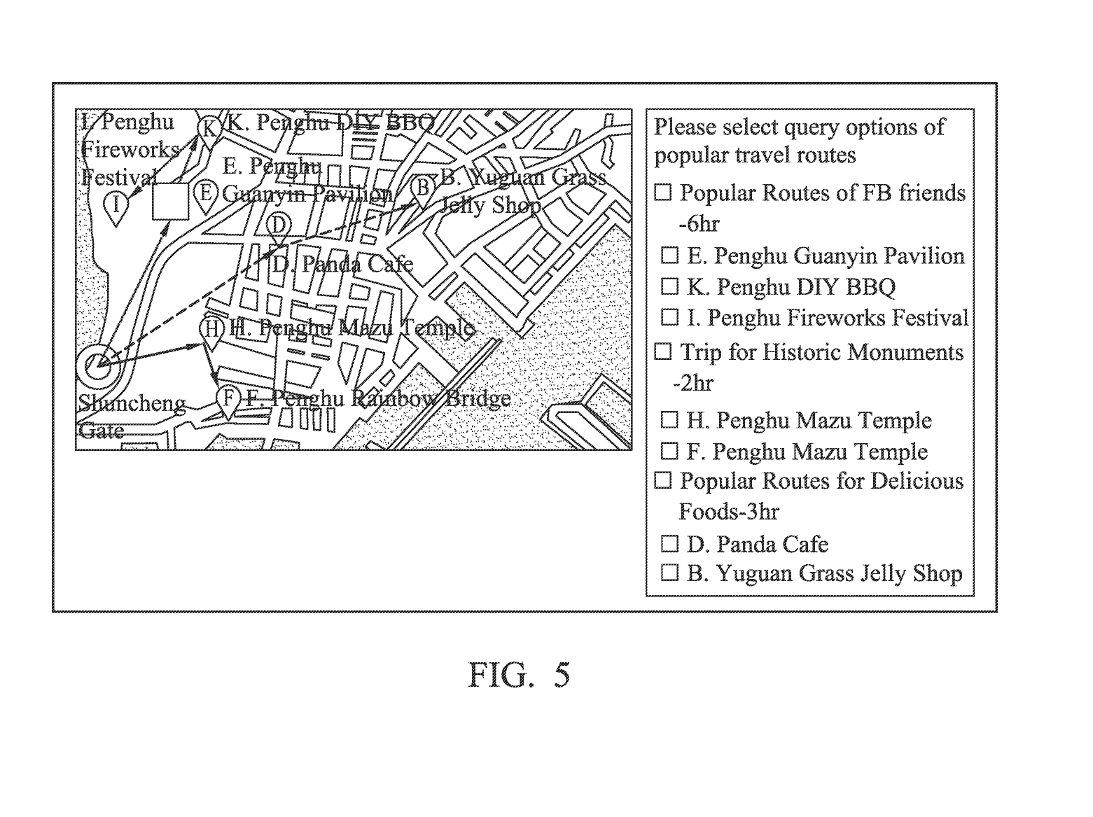

FIG. 5 is a diagram illustrating querying routes by using the user interface according to an embodiment of the invention. In an embodiment, the processing unit 122 may generate candidate data corresponding to different types, such as the shortest path, travel route of friends, popular routes in the social network, historic monuments, delicious food, but the invention is not limited thereto. Specifically, when the user queries travel routes by using the user interface, the user may set a specific type to add to the query information. Then, the processing unit 122 may generate a recommended travel route from the candidate data stored in the database 123 according to the location and the specific type of the query information from the user.

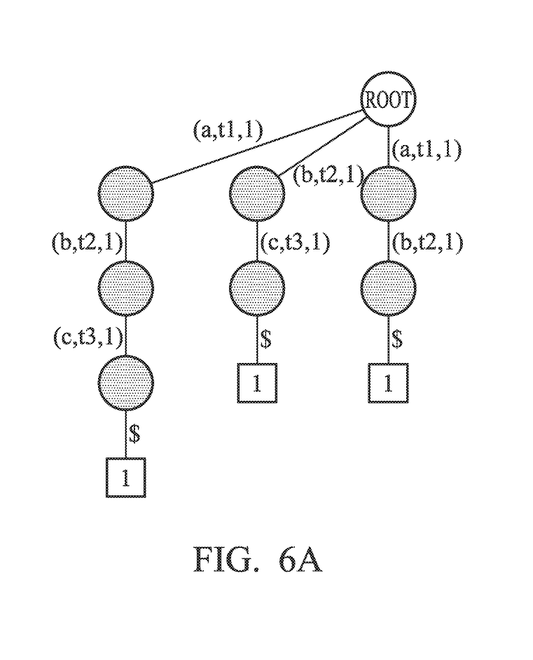

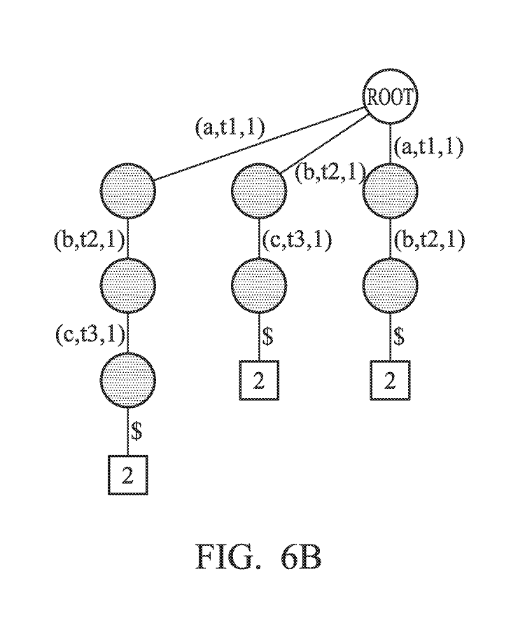

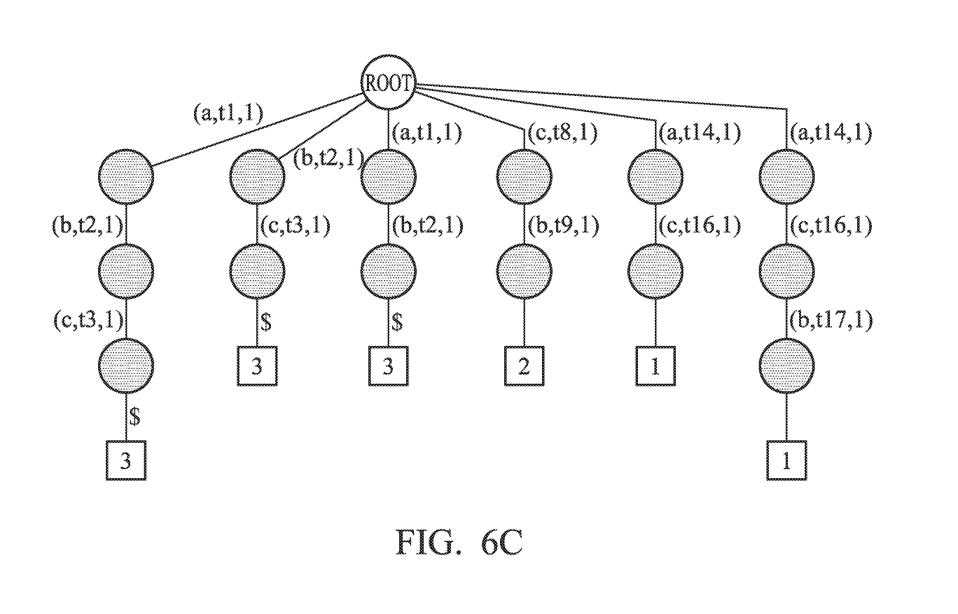

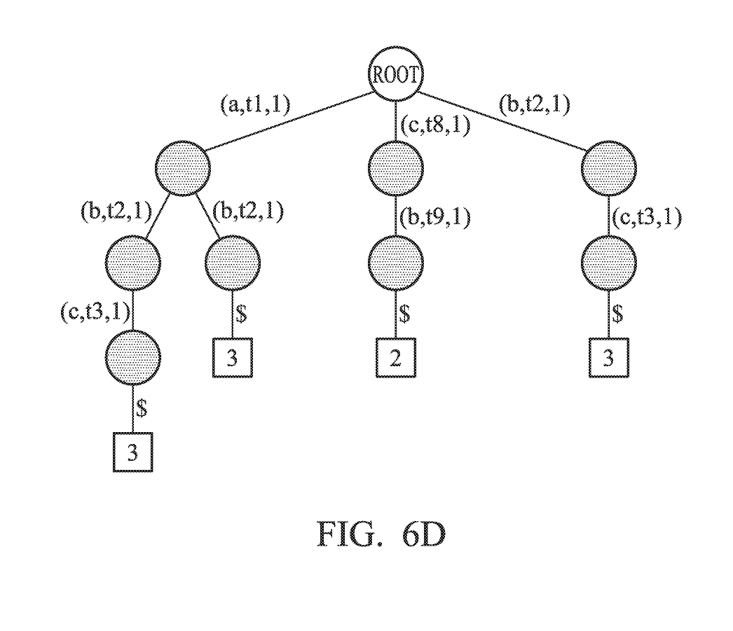

FIGS. 6A˜6D are diagrams illustrating calculation of n-gram sequential route data and the number of occurrences by using an SMAP-Tree according to an embodiment of the invention. Referring to both FIG. 4B and FIG. 6A, in an embodiment, since each move data may comprise multiple pieces of time-to-location information, the processing unit 122 may start from ROOT to fill the time-to-location information of each move data in the form of strings. For example, the n-gram sequential route data of the move data associated with the user A are (a, t1, 1)(b, t2, 1), (b, t2, 1)(c, t3, 1), and (a, t1, 1)(b, t2, 1)(c, t3, 1), and each sequential route data has a symbol $ as an end. Then, as illustrated in FIG. 6B, the processing unit 122 may fill the n-gram sequential route data of the move data associated with the user B, and the number value in each n-gram sequential route data is based on the prior filled n-gram sequential route data. For example, there is a n-gram sequential route data (a, t1, 1)(b, t2, 1)(c, t3, 1) associated with the user A, and there is n-gram continuous data (a, t1, 1)(b, t6, 1)(c, t6, 1) and (a, t10, 1)(b, t11, 1)(c, t12, 1) associated with the users B and D, respectively. The time-to-location information of each n-gram sequential route data in FIG. 6B is based on the prior filled n-gram continuous data associated with the user A. After the processing unit 122 has filled each sequential route data of all the move data, an SMAP-tree is built, as illustrated in FIG. 6C. Since there is continuity between multiple pieces of time-to-location information of the move data, a string suffix will be filled into a leaf of a node if the node is repeated. For example, there are multiple data starting from the (a, t1, 1) node, and there are two leaves from the (a, t1, 1) node, as illustrated in FIG. 6C. Then, the processing unit 122 may start from ROOT of the SMAP-tree, and calculate the number of occurrences of each leaf. The processing unit 122 may only preserve the leaf nodes having a number of occurrences exceeding a predetermined number (e.g. twice), thereby obtaining the SMAP-tree of popular routes, as illustrated in FIG. 6D. It should be noted that the method to build popular routes disclosed in the aforementioned embodiment of FIGS. 6A˜6D is only for description, but the invention is not limited thereto.

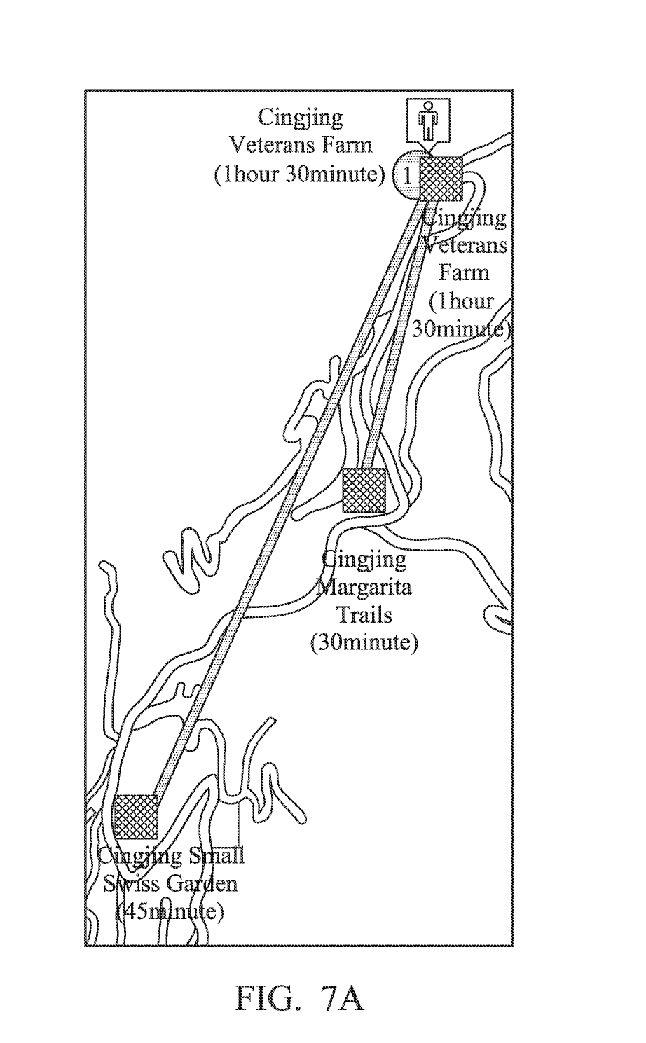

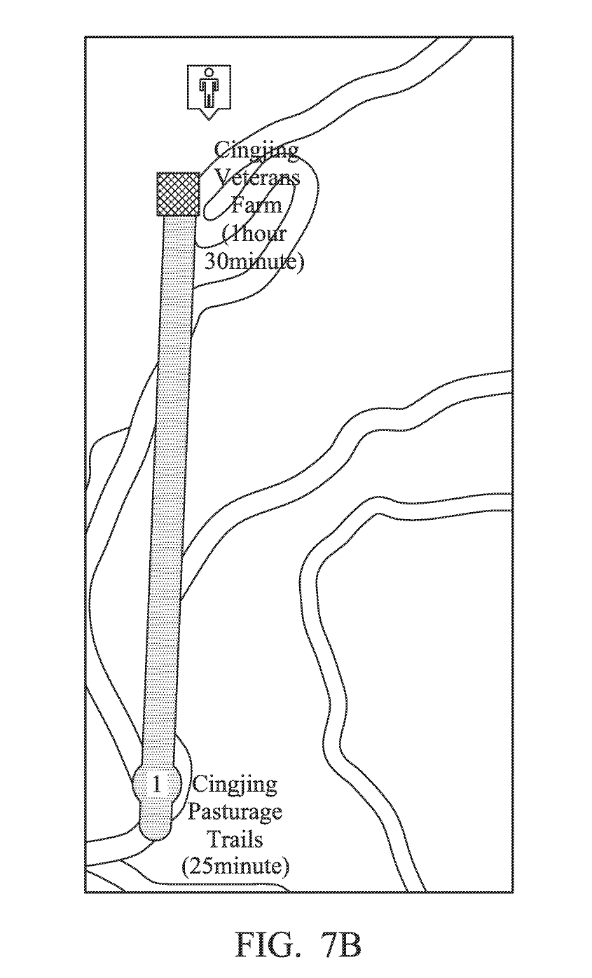

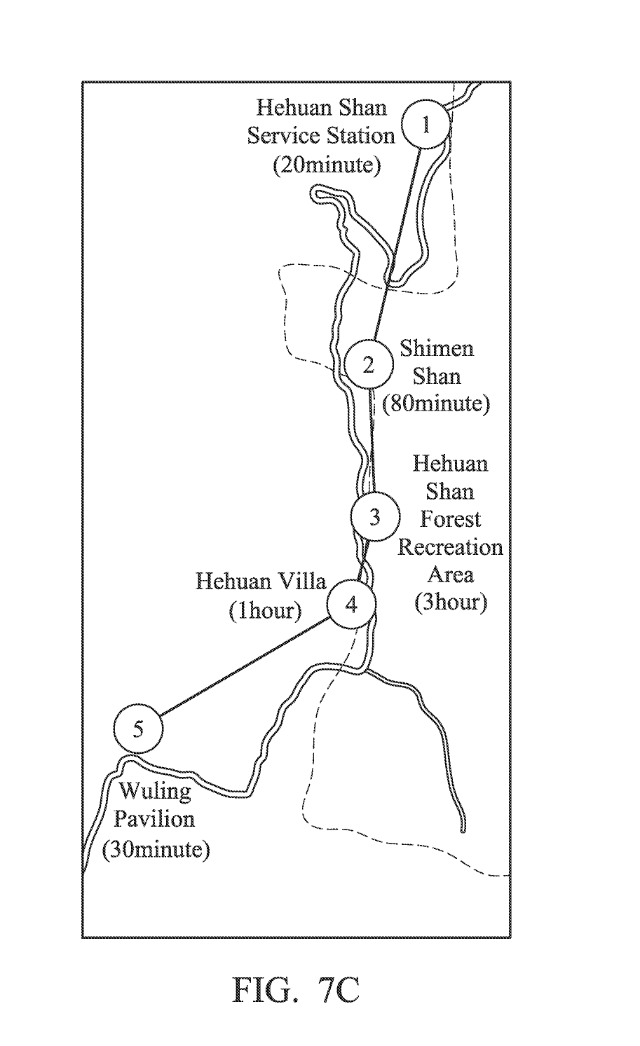

FIGS. 7A˜7C are diagrams illustrating different recommended travel routes according to different embodiments of the invention. In an embodiment, when a user selects the attraction “Cingjing Veterans Farm” and queries recommended travel routes around (e.g. within a distance of 1 km), the processing unit 122 may retrieve recommended travel routes around the attraction “Cingjing Veterans Farm” from the database 123 according to the query information from the user, and provide the retrieved recommended travel routes to the user. For example, the 2-gram sequential route data having a type of the move data “sight-seeing” within a distance of 1 km away from the attraction “Cingjing Veterans Farm” in the candidate data stored in the database 123 are only (d, t1)(e, t2) and (d, t3)(f, t4). The processing unit 122 may recommended the 2-gram sequential route data (d, t1)(e, t2) or (d, t3)(f, t4), wherein the location d denotes the attraction “Cingjing Veterans Farm”; the location e denotes the attraction “Cingjing Margarita Trails”; the location f denotes the attraction “Cingjing Small Swiss Garden”. As illustrated in FIG. 7B, when the user selects the attraction “Cingjing Pasturage Trails” (i.e. corresponding to the location g) and queries recommended travel routes around (e.g. within a distance of 1 km), the processing unit 122 may generate a recommended route from 2-gram sequential route data (g, t5)(d, t6), which indicates the travel route from “Cingjing Pasturage Trails” to “Cingjing Veterans Farm”.

In some other embodiments, the filtered move data can be stored in the database 123, or stored in another storage device/database for being read by the processing unit 122 while calculating and generating the candidate data. That is, the aforementioned filtered move data can be read from the database 123 or other storage device/database without being filtered again, thereby saving time for processing the candidate data. Further, in yet some other embodiments, every time the processing unit 122 receives query information, the processing unit 122 may regenerate at least one candidate data according to the query information and the filtered move data stored in the database 123, and then generate at least one recommended route. As illustrated in FIG. 7C, when the user inputs the attraction “Hehuan Shan Service Station” and queries recommended routes around through the user interface 111, the processing unit 122 may display corresponding map data around the attraction “Hehuan Shan Service Station” on the user interface 111. The processing unit 122 may retrieve all the filtered move data corresponding to nearby areas of the attraction “Hehuan Shan Service Station” from the database 123, thereby generating candidate routes. In the embodiment, the candidate route having the longest path (i.e. the longest route) is regarded as the recommended route. For example, the longest route generated by the processing unit 122 is (h, t7)(i, t8)(j, t9)(k, t10)(l, t11), wherein the locations h˜l correspond to the attractions “Hehuan Shan Service Station”, “Shimen Shan”, “Hehuan Shan Forest Recreation Area”, “Hehuan Villa”, and “Wuling Pavilion”, respectively. That is, the first location of the longest route is “Hehuan Shan Service Station”; the second location is “Shimen Shan”; the third location is “Hehuan Shan Forest Recreation Area”; the fourth location is “Hehuan Villa”; and the last location is “Wuling Pavilion”. Accordingly, the processing unit 122 may set the route having the most attractions as the recommended route, and transmit the recommended route back to the data querying apparatus 110. It should be noted that the method for calculating the respective recommended staying time of each location in the recommended route in the aforementioned embodiment is applied in the embodiment of FIGS. 7A˜7C. Accordingly, each attraction in the recommended route displayed on the user interface may have a recommended staying time.

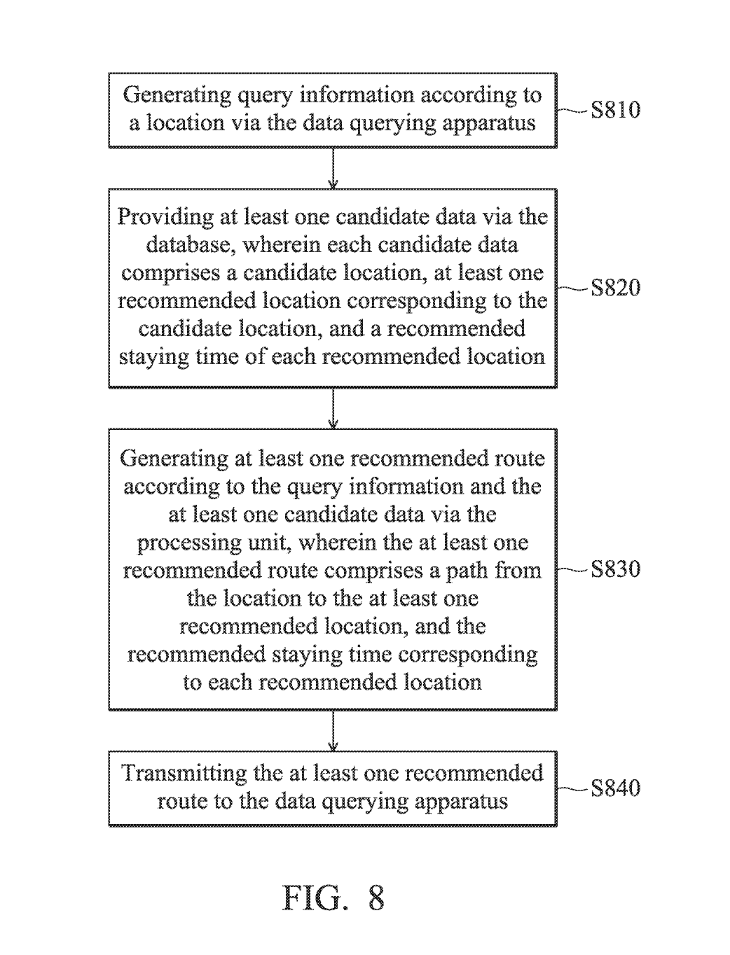

FIG. 8 is a flow chart illustrating a route recommendation method according to an embodiment of the invention. Before performing the procedure of FIG. 8, the data receiving unit 121 may retrieve multiple pieces of time information and corresponding location information of at least one user in a period of time (i.e. the move data of at least one user) from the internet, a social network (e.g. Facebook), or a mobile device. The multiple pieces of time information and corresponding location information may be check-in information in a social network, photos having the time/location information, videos having the location information, and/or documents having the time/location information. In step S810, the data querying apparatus 110 is used to generate query information according to a location. For example, a user may input a location name on the user interface 111, or directly select a location on the map of the user interface 111 to obtain a location name. In step S820, the database may provide at least one candidate data, wherein each candidate data comprises a candidate location, corresponding to at least one recommended location, and a recommended staying time of each recommended location. It should be noted that the data analyzing apparatus 120 may retrieve move data (i.e. comprising at least two consecutive time-to-location information) of at least one user from the internet, a social network, or a mobile device, wherein the multiple pieces of time information and corresponding location information may be checkin information in a social network, photos having the time/location information, videos having the location information, and/or documents having the time/location information. The processing unit 122 may generate the at least one recommended location corresponding to the at least one candidate data according to the multiple pieces of time information and corresponding location information of the at least one user within a period of time, and store the candidate data in the database 123.

In step S830, the processing unit 122 may generate at least one recommended route according to the query information and the at least one candidate data, wherein the at least one recommended route comprises a path from the location to the at least one recommended location, and a recommended staying time corresponding to each recommended location. In step S840, the processing unit 122 may transmit the at least one recommended route to the data querying apparatus 110. Specifically, the processing unit 122 may calculate at least one recommended travel route from the at least one move data stored in the database 123 according to the query information, wherein the at least one recommended travel route comprises at least two consecutive attractions and a recommended staying time corresponding to the at least two consecutive attractions.

Techniques and implementation details applied in the route recommendation method are the same with those in the aforementioned embodiments, and the details will not be described here again. The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

When the invention is implemented in the form of a program code, the program code can be stored in a storage medium for being read by a data querying apparatus and a data analyzing apparatus to execute the route recommendation method in the invention, the data analyzing apparatus, which is connected to the data querying apparatus, comprising a database, a data receiving unit and a processing unit, the method comprising: generating query information according to a location via the data querying apparatus; storing at least one candidate data via the database, wherein each candidate data comprises a candidate location, at least one recommended location corresponding to the candidate location, and a recommended staying time of each recommended location; receiving the querying information via the data receiving unit; generating at least one recommended route according to the query information and the at least one candidate data via the processing unit; and transmitting the at least one recommended route to the data querying apparatus, wherein the at least one recommended route comprises a path from the location to the at least one recommended location, and the recommended staying time corresponding to the at least one recommended location.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A route recommendation system, comprising
a data querying apparatus configured to generate query information according to a location; and
a data analyzing apparatus, connected to the data querying apparatus, comprising:
a database configured to store at least one candidate data, wherein each candidate data comprises a candidate location, at least one recommended location corresponding to the candidate location, and a recommended staying time corresponding to each recommended location;
a data receiving unit configured to receive the query information; and
a processing unit configured to generate at least one recommended route according to the query information and the at least one candidate data, and transmit the at least one recommended route to the data querying apparatus, wherein the at least one recommended route comprises a path from the location to the at least one recommended location, and the recommended staying time corresponding to the at least one recommended location.

2. The route recommendation system as claimed in claim 1, wherein the processing unit further generates the at least one candidate data according to multiple pieces of time information and the corresponding location information of each of at least one user in a period of time.

3. The route recommendation system as claimed in claim 2, wherein the processing unit further generates each candidate data and the at least one recommended location thereof according to the multiple pieces of time information and the corresponding location information, and generates the recommended staying time corresponding to each recommended location according to the multiple pieces of time information.

4. The route recommendation system as claimed in claim 1, wherein the data querying apparatus further provides a user interface to display a map corresponding to the location and the at least one recommended route, wherein the location, the at least one recommended location, the path from the location to the at least one recommended location, and the recommended staying time corresponding to each recommended location are displayed on the map.

5. The route recommendation system as claimed in claim 4, wherein the user interface further provides multiple selectable locations for a user, and the processing unit further sets the selectable locations selected by the user as the location to generate the query information and the at least one recommended route.

6. The route recommendation system as claimed in claim 2, wherein the multiple pieces of time information and the corresponding location information indicate a set of move data of any user within any period of time, and each set of move data comprises at least two time-to-location information, and each time-to-location information at least comprises a time information and a location information.

7. The route recommendation system as claimed in claim 6, wherein the processing unit further generates a set of routes comprising multiple sequential route data and calculates a number of occurrences of each sequential route data according to multiple sets of move data, and generates at least one recommended location corresponding to each candidate location according to the number of occurrences, wherein each sequential route data comprises at least two consecutive time-to-location information retrieved from any set of move data.

8. The route recommendation system as claimed in claim 7, wherein the processing unit further compares the number of occurrences of each sequential route occurrences larger than or equal to the predetermined number as the candidate data, and generates the recommended route from the candidate data according to the query information.

9. The route recommendation system as claimed in claim 2, wherein the multiple pieces of time information and the corresponding location information are retrieved from one of the internet, a social network, and a mobile device, and each time information and the corresponding location information indicate one of a checkin information in the social network, photos having the time information and the location information, videos having the location information, and documents having the time information and the location information.

10. The route recommendation system as claimed in claim 2, wherein each candidate data further comprises a type of the move data, and the data querying apparatus further generates the query information according to a specific type and the location, and the processing unit further generates the recommended route according to the query information and the at least one candidate data.

11. A route recommendation method applied in a route recommendation system, wherein the route recommendation system comprises a data querying apparatus and a data analyzing apparatus, and the data analyzing apparatus, which is connected to the data querying apparatus, comprises a database, a data receiving unit and a processing unit, the method comprising:
generating query information according to a location via the data querying apparatus;
storing at least one candidate data via the database, wherein each candidate data comprises a candidate location, at least one recommended location corresponding to the candidate location, and a recommended staying time of each recommended location;
generating at least one recommended route according to the query information and the at least one candidate data via the processing unit; and
transmitting the at least one recommended route to the data querying apparatus, wherein the at least one recommended route comprises a path from the location to the at least one recommended location, and the recommended staying time corresponding to each recommended location.

12. The route recommendation method as claimed in claim 11, further comprising:
generating the at least one candidate data according to multiple pieces of time information and the corresponding location information of at least one user in a period of time via the processing unit.

13. The route recommendation method as claimed in claim 12, further comprising:
using the processing unit to perform the following steps of:
generating each candidate data and the at least one recommended location thereof according to the multiple pieces of time information and the corresponding location information; and
generating the recommended staying time corresponding to each recommended location according to the multiple pieces of time information.

14. The route recommendation method as claimed in claim 11, further comprising:
providing a user interface via the data querying apparatus to display a map corresponding to the location and the at least one recommended route, wherein the location, the at least one recommended location, the path recommended staying time corresponding to each recommended location are displayed on the map.

15. The route recommendation method as claimed in claim 14, wherein the user interface further provides multiple selectable locations for a user, and the processing unit further sets the selectable location selected by the user as the location to generate the query information and the at least one recommended route.

16. The route recommendation method as claimed in claim 12, wherein the multiple pieces of time information and the corresponding location information indicate a set of move data of any user within any period of time, and each set of move data comprises at least two time-to-location information, and each time-to-location information at least comprises a time information and a location information.

17. The route recommendation method as claimed in claim 16, further comprising:
using the processing unit to perform the following steps of:
generating a set of routes comprising multiple sequential route data and calculates a number of occurrences of each sequential route data according multiple sets of move data; and
generating at least one recommended location corresponding to each candidate location according to the number of occurrences via the processing unit, wherein each sequential route data comprises at least two consecutive time-to-location information retrieved from any set of move data.

18. The route recommendation method as claimed in claim 17, further comprising:
using the processing unit to perform the following steps of:
comparing the number of occurrences of each sequential route data with a predetermined number;
setting the sequential route data having the number of occurrence larger than or equal to the predetermined number as the candidate data; and
generating the recommended route from the candidate data according to the query information.

19. The route recommendation method as claimed in claim 12, wherein the multiple pieces of time information and the corresponding location information are retrieved from one of the internet, a social network, and a mobile device, and each time information and the corresponding location information indicate one of a checkin information in the social network, photos having the time information and the location information, videos having the location information, and documents having the time information and the location information.

20. The route recommendation method as claimed in claim 12, wherein each candidate data further comprises a type of the move data, and the method further comprises:
generating the query information according to a specific type and the location via the data querying apparatus; and
generating the recommended route according to the query information and the at least one candidate data via the processing unit.

21. A non-transitory storage medium for being read by a data querying apparatus and a data analyzing apparatus to execute a route recommendation method, wherein the data analyzing apparatus, which is connected to the data querying apparatus, comprises a database, a data receiving unit, and a processing unit, the method comprising:
generating query information according to a location via the data querying apparatus;
storing at least one candidate data via the database, wherein each candidate location corresponding to the candidate location, and a recommended staying time of each recommended location;
receiving the querying information via the data receiving unit;
generating at least one recommended route according to the query information and the at least one candidate data via the processing unit; and
transmitting the at least one recommended route to the data querying apparatus, wherein the at least one recommended route comprises a path from the location to the at least one recommended location, and the recommended staying time corresponding to each recommended location.
